(19) United States
(12) Patent Application Publication
(10) Pub. No.: US 2015/0310313 A1
(43) Pub. Date: Oct. 29, 2015

(54) VISIBILITY ESTIMATION DEVICE, VISIBILITY ESTIMATION METHOD, AND SAFE DRIVING SUPPORT SYSTEM

(71) Applicants: Shu MURAYAMA, Chiyoda-ku, Tokyo (JP); Jumpei HATO, Chiyoda-ku, Tokyo (JP)

(72) Inventors: Shu MURAYAMA, Chiyoda-ku (JP); Jumpei HATO, Chiyoda-ku (JP)

(73) Assignee: MITSUBISHI ELECTRIC CORPORATION, Chiyoda-ku, Tokyo (JP)

(21) Appl. No.: 14/443,120

(22) PCT Filed: Dec. 18, 2012
(86) PCT No.: PCT/JP2012/008060

§ 371 Date: May 15, 2015

(51) Int. Cl. G06K 9/62; B60Q 9/00; G06K 9/00; B60K 35/00

(52) U.S. Cl. CPC G06K 9/6267; B60K 35/00; B60Q 9/00; G06K 9/00791; G06K 9/6215

(57) ABSTRACT

A device to estimate visibility change of surroundings, including: an image recognition unit that detects a landmark by analyzing an image; an information storage unit that records, as a detection history in the past, an image analysis result of the landmark detected by the image recognition unit and a detection position when the landmark is detected by the image recognition unit; and a visibility judgment unit that estimates, when the landmark corresponding to the detection history recorded in the information storage unit is detected again by the image recognition unit, change in visibility on the basis of comparison between a detection position when detected again and the detection position in the past recorded in the information storage unit.

### TECHNICAL FIELD

When a user such as a driver or a pedestrian is notified of various pieces of information, excessive notification sometimes interferes with driving or walking. The present invention relates to a control technology for avoiding such interference.

### BACKGROUND ART

In order to improve safety when driving a car, various safe driving support technologies have been researched and developed recently. For example, there exist a system in which, when coming close to a preceding or surrounding vehicle, a warning is displayed on an in-vehicle display device or notification is made by emitting a warning sound from a loudspeaker, and a system in which existence of a pedestrian and a road sign, etc. on the road shoulder is notified so that the driver will not overlook them.

However, when various safe driving support technologies described above are introduced, caution should be exercised so that decrease in attentiveness of the driver is not invited by excessively notifying the driver of the information. For example, since there exist a lot of pedestrians and road signs when driving through a town, if the driver is notified of all of them, the driver feels the notification bothersome and it may cause a problem that the information which should be proactively notified is not correctly transmitted to the driver.

In order to avoid such a problem, there is a method of carefully selecting information to be notified according to various conditions. For example, there is a method in which road signs and surroundings thereof are captured by a camera and road signs which are not easy to recognize are only displayed on the basis of the number of edges at the surroundings of the signs and the information about the color of the signs (Patent Document 1).

There is another method in which map information as well as road sign information (character data, etc.) are recorded in advance in a navigation device and, only if information of a road sign captured by a camera during driving differs from the information recorded in advance, the road sign concerned is displayed so that an excessive display is suppressed (Patent Document 2).

### PRIOR ART DOCUMENT

Patent Document

Patent Document 1: Japanese Unexamined Patent Application Publication No. 2010-239448

Patent Document 2: Japanese Unexamined Patent Application Publication No. 2005.300342

### SUMMARY OF THE INVENTION

### Problems that the Invention is to Solve

The method described in Patent Document 1 is that, by judging whether or not a road sign is easy to recognize, the road sign is displayed only if it is blended into the surrounding scenery and thus its visibility is decreased. Therefore, the method cannot estimate visibility change of the surroundings. In addition, if there are many road signs having low visibility, all of them are to be displayed. Especially in a case where a road sign along a frequently driving road is not easy to recognize but a driver has already understood displayed contents thereof, the driver feels it bothersome if the road sign like that which is not easy to recognize is repeatedly displayed every time when passing by the same road. This causes a problem that decrease in attentiveness is invited and safe driving may be disturbed.

The method described in Patent Document 2 is that, by comparing a road sign recorded with map information and a road sign detected during driving, whether or not the two signs are different is merely determined, and therefore the method cannot judge visibility change. In addition, while repeatedly displaying a road sign every time when passing by the same point can be avoided, the method is specialized on the display of road signs and thus it does not have an effect to control so as to avoid excessive notification of other targets to be notified such as the above-described pedestrians. Especially for pedestrians who have characteristics of not always being at the same position, the method is useless since a target has been recorded in association with a map and judgment whether or not to notify is made depending on the presence or absence of change in the target.

The present invention has been made in order to solve the above-described problems, and an objective thereof is to estimate visibility change by monitoring how the easiness to see a landmark such as a road sign changes. In addition, another objective thereof is to suppress excessive notification of information to a user by estimating visibility change compared to the past and thus by determining surrounding visibility, i.e. whether the user can recognize surrounding conditions from a position having enough distance therefrom.

### Means for Solving the Problem

A visibility estimation device according to the present invention includes: an image recognition unit that detects a landmark by analyzing an image; an information storage unit that records, as a detection history regarding the landmark in the past, an image analysis result of the landmark detected by the image recognition unit and a detection position when the landmark is detected by the image recognition unit; and a visibility judgment unit that estimates, when the landmark corresponding to the detection history is detected again by the image recognition unit, change in visibility on the basis of comparison between a detection position when detected again and the detection position in the past recorded in the information storage unit.

Also, a visibility estimation device includes: an image recognition unit that detects a landmark by analyzing an image; an information storage unit that records, as a detection history regarding the landmark in the past, an image analysis result of the landmark detected by the image recognition unit and a detection position when the landmark is detected by the image recognition unit; and a visibility judgment unit that estimates change in visibility on the basis of comparison between image analysis progress of the landmark analyzed again by the image recognition unit at the detection position in the past recorded in the information storage unit and the image analysis result in the past recorded in the information storage unit.

In addition, a visibility estimation device includes: an image recognition unit that detects a landmark by analyzing an image; an information storage unit that records, as a detection history regarding the landmark in the past, a detection distance from a position when the landmark is detected by the image recognition unit to the landmark; and a visibility judgment unit that estimates, when the landmark corresponding to the detection history is detected again by the image recognition unit, change in visibility on the basis of comparison between a detection distance when detected again and the detection distance in the past recorded in the information storage unit.

A visibility estimation method according to the present invention includes steps of: detecting a landmark by analyzing an image; recording, as a detection history regarding the landmark in the past, an image analysis result of the detected landmark and a detection position when the landmark is detected; and estimating, when the landmark corresponding to the detection history is detected again, change in visibility on the basis of comparison between a detection position when detected again and the recorded detection position in the past.

Also, a visibility estimation method includes steps of: detecting a landmark by analyzing an image; recording, as a detection history regarding the landmark in the past, an image analysis result of the detected landmark and a detection position when the landmark is detected; and estimating change in visibility on the basis of comparison between image analysis progress of the landmark detected again at the detection position in the past and the recorded image analysis result in the past.

In addition, a visibility estimation method includes steps of: detecting a landmark by analyzing an image; recording, as a detection history regarding the landmark in the past, a detection distance from a position when the landmark is detected to the landmark; and estimating, when the landmark corresponding to the detection history is detected again, change in visibility on the basis of comparison between a detection distance when detected again and the recorded detection distance in the past.

A safe driving support system according to the present invention includes: an image recognition unit that detects a landmark by analyzing an image; an information storage unit that records, as a detection history regarding the landmark in the past, an image analysis result of the landmark detected by the image recognition unit and a detection position when the landmark is detected by the image recognition unit; a visibility judgment unit that estimates, when the landmark corresponding to the detection history is detected again by the image recognition unit, change in visibility on the basis of comparison between a detection result when detected again and the detection history in the past recorded in the information storage unit; an information provision determination unit that reduces, when current visibility is estimated by the visibility judgment unit to be decreased compared to visibility in the past, a threshold for determining that safety support information regarding surroundings is necessary to be provided to a user; and an information provision unit that provides, when provision of the information is determined by the information provision determination unit, the information to the user.

### Advantageous Effects of the Invention

By using a visibility estimation device and a visibility estimation method according to the present invention, visibility change, e.g. whether the visibility is as usual or is decreased, can be estimated. In addition, by estimating the visibility change in this way, information on surroundings can be transmitted to a user only when the visibility is decreased, and thus an amount of information to be notified can be suppressed.

### BRIEF DESCRIPTION OF DRAWINGS

FIG. 1 is a diagram showing a visibility estimation device according to Embodiment 1 of the present invention.

FIG. 2 is a diagram showing a visibility judgment flow according to Embodiment 1 of the present invention.

FIG. 3 is a diagram showing a visibility estimation device according to Embodiment 2 of the present invention.

FIG. 4 is a diagram showing a visibility judgment flow according to Embodiment 2 of the present invention.

FIG. 5 is a diagram showing a visibility estimation device according to Embodiment 3 of the present invention.

FIG. 6 is a diagram showing a visibility estimation device according to Embodiment 5 of the present invention.

FIG. 7 is a diagram showing a visibility estimation device according to Embodiment 7 of the present invention.

FIG. 8 is a diagram showing a visibility estimation device according to Embodiment 8 of the present invention.

FIG. 9 is a diagram showing a safe driving support system according to Embodiment 9 of the present invention.

### MODE FOR CARRYING OUT THE INVENTION

### Embodiment 1

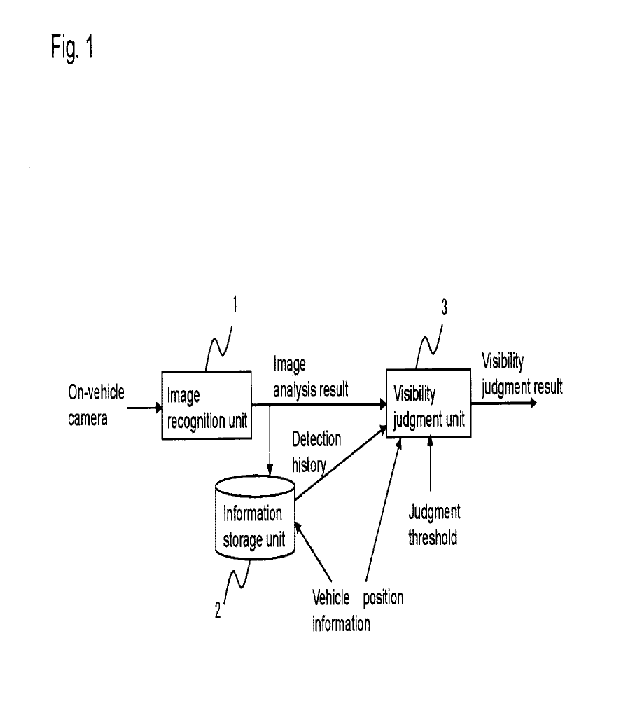

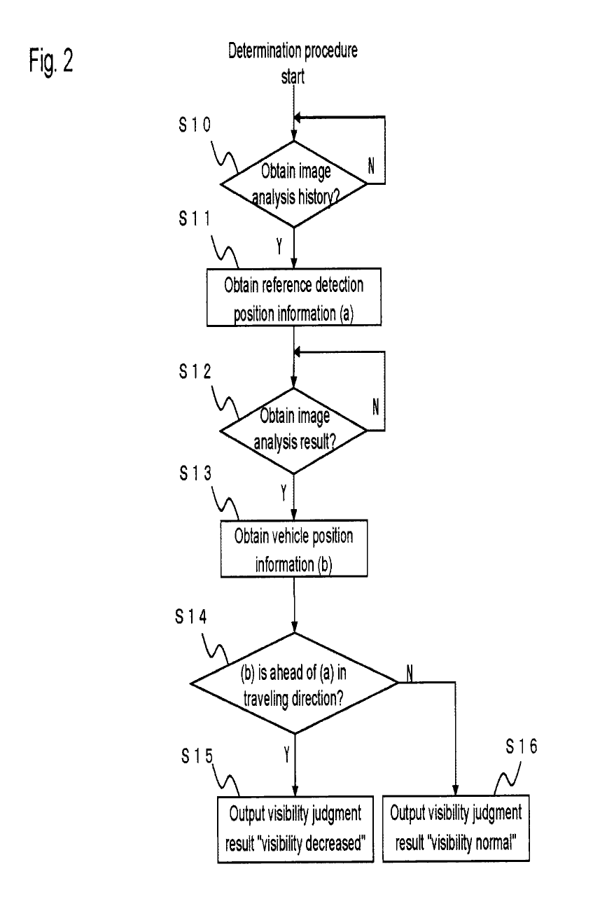

FIG. 1 is a diagram showing a visibility estimation device according to Embodiment 1 of the present invention. While examples of a visibility estimation device include a device for estimating driver's visibility while driving a vehicle as well as a device for estimating pedestrian's visibility, a device for estimating driver's visibility will be explained in Embodiment 1. The same will apply to the following embodiments. As shown in FIG. 1, the visibility estimation device according to Embodiment 1 is configured with an image recognition unit 1, an information storage unit 2, and a visibility judgment unit 3. FIG. 2 shows a visibility judgment flow in the visibility judgment unit 3.

The image recognition unit 1 is mounted on a vehicle, receives an image from an on-vehicle camera for photographing the front of traveling direction, and outputs an image analysis result to the information storage unit 2 and visibility judgment unit 3. The image recognition unit 1 has a function of detecting landmarks such as a road sign, a traffic signal, and a signboard of a convenience store, and outputs their types and described contents if they can be detected. For example, as to a road sign, information such as “speed-limit sign” and “40 km/h” is outputted as the image analysis result, while information such as “no detection” or nothing is outputted if nothing can be detected.

The information storage unit 2 has functions of receiving the image analysis result outputted from the image recognition unit 1 and information of vehicle position at the time when the landmark concerned is detected, associating the result and the information with each other, and recording them, as a detection history in the past, in a storage medium (not shown) such as an internal HDD. The vehicle position information in the past being one of detection histories recorded in the information storage unit 2 serves as reference detection position information (detection position in the past) and is used as a determination criterion when estimating visibility. The vehicle position information is generated by GPS (Global Positioning System) widely used in a car navigation device, etc., and correctly shows a current position of vehicle. The vehicle position information includes coordinates such as latitude and longitude as well as vehicle direction information. The information is generated by a gyro sensor, etc. also widely used in a car navigation device, etc. In addition, when a vehicle is running at certain coordinates and in a certain direction, if vehicle position information at that time and an image analysis history associated with the vehicle position information have been recorded, the information storage unit 2 outputs them as a detection history.

The visibility judgment unit 3 finally judges visibility on the basis of the current image analysis result obtained from the image recognition unit 1, the current vehicle position, the detection history obtained from the information storage unit 2, and a judgment threshold, and then outputs the judgment result.

Next, an operation of the visibility judgment unit 3 will be explained by using FIGS. 1 and 2.

For example, when a vehicle during driving approaches a point where a speed-limit sign of 40 km/h was detected in the past, data of “speed-limit sign” and “40 km/h” is inputted as an image analysis history from the information storage unit 2 (S100), and reference detection position information (a) being a detection position in the past associated with the image analysis history is inputted (S101).

If the image recognition unit 1 detects a road sign same as the sign which was detected at the same point, “speed-limit sign” and “40 km/h” are inputted as the image analysis result from the image recognition unit 1 (S102), and vehicle position information (b) at that time is inputted (S103). In this case, since the reference detection position information (a) coincides with the current vehicle position information (b), it is determined that visibility in a vehicle traveling direction has not changed and “visibility normal” is outputted as the visibility judgment result (S104, S106). Note that, while almost no visibility change is assumed to occur actually, it may be possible that there is some variation in a position where a road sign can be recognized, and thus control of considering positions within a certain range as the same point is performed.

On the other hand, when visibility is poor, for example, due to fog, etc., detection of a road sign should be made from a closer position than usual. Specifically, when a vehicle approaches a point where a road sign was detected in the past, while the information storage unit 2 notifies the visibility judgment unit 3 of the image analysis history and reference detection position information (S100, S101), the image recognition unit 1 does not notify the unit 3 of the image analysis result since the image recognition unit 1 has not yet detected the road sign at the point. When the vehicle further advances in its traveling direction and completes the detection of the road sign, the image analysis result is then notified for the first time (S102) and the vehicle position information (b) at that time is inputted (S103).

In this case, since the reference detection position information (a) for the road sign differs from the vehicle position information (b) for the same sign, it is determined that visibility change occurs. In the above-described example, since the coordinates of vehicle position information (b) is located ahead of the coordinates of reference detection position information (a) in a vehicle traveling direction, it is determined that visibility is decreased (S104, S105). Here, a judgment threshold is inputted from the external as a determination criterion for determining whether the visibility is decreased on the basis of the position change. For example, when the judgment threshold is set to be 2 m, if the vehicle travels a distance of 2 m or less during a period from the notification of road sign detection as the image analysis history to the notification of road sign detection as the image analysis result, it is determined that visibility has not changed and “visibility normal” is outputted as the visibility judgment result. On the other hand, if the vehicle travels a distance of more than 2 m, e.g. 4 m, “visibility decreased” is outputted as the visibility judgment result.

Note that, while the threshold is obtained from the external in the above-described explanation, a threshold may be recorded in the visibility judgment unit 3.

Also, the image analysis history stored in the information storage unit 2 and the reference detection position information corresponding thereto may be updated every time when the image analysis result is inputted from the image recognition unit 1. However, if measurement cannot be made due to an obstacle located ahead, the analysis result may not be recorded or the influence thereof may be reduced by averaging a plurality of analysis results. Or, the data may be updated so as to record the image analysis result when visibility is good, which is associated with the corresponding vehicle position, as the image analysis history. As to whether visibility is good or poor, visibility may be determined to be good if the coordinates of vehicle position information (b) is located rear of the coordinates of reference detection position information (a) with respect to a vehicle traveling direction, or it may be determined depending on the brightness, etc. In addition, the image analysis result when a landmark is detected for the first time and the vehicle position information corresponding thereto may be only recorded as a reference detection history.

As described above, the driver's visibility estimation device according to the embodiment can estimate visibility change by comparing a position where an object (landmark) fixedly set up ahead of the road in a traveling direction, such as a road sign, is detected with the detection position in the past. Also, since necessity of providing information about other objects detected at the surroundings can be determined on the basis of the estimated visibility change, excessive provision of the information to a driver can be suppressed.

### Embodiment 2

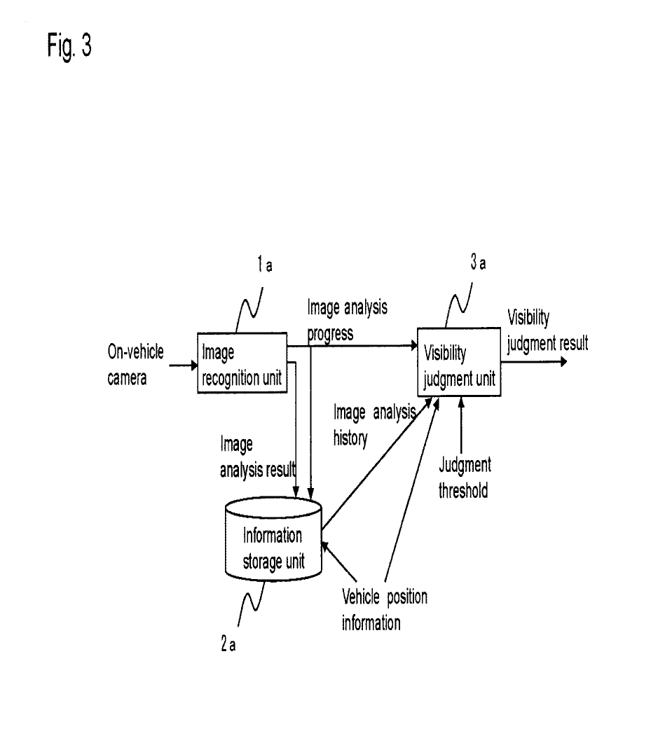

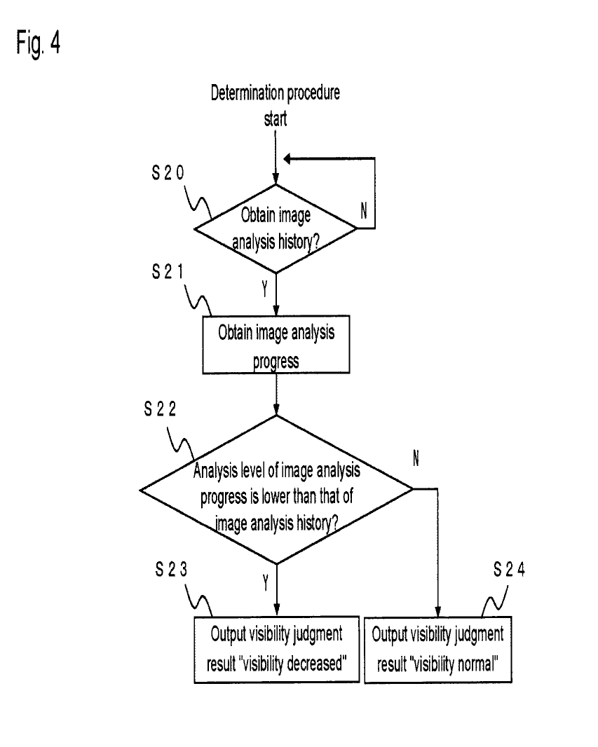

FIG. 3 is a diagram showing a driver's visibility estimation device according to Embodiment 2 of the present invention. Differences between FIG. 1 and FIG. 3 are that image analysis progress instead of the image analysis result is outputted from an image recognition unit 1a to a visibility judgment unit 3a and that the image analysis progress is stored in an information storage unit 2a. That is, while the image recognition unit 1 in Embodiment 1 outputs types and described contents of road signs, etc., which are targets to be detected, after they can be detected completely, the image recognition unit 1a in Embodiment 2 outputs the image analysis progress at a time when passing by a predetermined point even if the targets have not been detected completely. Since other than those are the same, the explanation thereof will be omitted. FIG. 4 shows a visibility judgment flow in the visibility judgment unit 3a.

A method of estimating driver's visibility according to Embodiment 2 will be explained by using FIGS. 3 and 4. First, when the image recognition unit 1a completely recognizes a certain road sign, etc. for the first time during driving, an image analysis result thereof is outputted to the information storage unit 2a at that point, and is stored as one of image analysis results in the past. For example, if a speed-limit road sign of “40 km/h” is situated ahead in a traveling direction, a vehicle position when the road sign can be completely recognized and an image analysis result of “speed-limit sign” and “40 km/h” are associated with each other, and they are recorded in the information storage unit 2a as detection histories in the past. The vehicle position being one of the detection histories recorded at that time is used as a reference position when the image recognition unit 1a outputs the image analysis progress in the following driving. Also, the image analysis result in the past, which is recorded at the same time, is outputted to the visibility judgment unit 3a as the image analysis history and is used as a determination criterion for visibility estimation when passing by the corresponding point in the following driving.

After that, when the vehicle passes by the reference position, the visibility judgment unit 3a obtains the image analysis history at that position from the information storage unit 2a (S200). At that time, contents that the image recognition unit 1a has already analyzed are notified to the visibility judgment unit 3a as the image analysis progress (S201). For example, when the image recognition unit 1a can detect that a road sign situated ahead in a traveling direction is “speed-limit sign” but cannot recognize a specific value written on the road sign, only “speed-limit sign” is outputted to the information storage unit 2a and visibility judgment unit 3a as the image analysis progress.

The visibility judgment unit 3a compares “speed-limit sign” inputted as the image analysis progress from the image recognition unit 1a with “speed-limit sign” and “40 km/h” being a determination criterion value inputted from the information storage unit 2 (S202). As a result of the comparison in this example, the visibility judgment unit 3a determines that an analysis level of the image analysis progress is lower than that of the image analysis history in the past, i.e. detected information included in the image analysis progress is fewer than that in the image analysis history in the past, estimates that visibility in a vehicle traveling direction is decreased, and outputs “visibility decreased” as the visibility judgment result (S203). On the other hand, if two analysis levels are the same, “visibility normal” is outputted as the visibility judgment result (S204).

As described above, by comparing an image analysis history being a detection history in the past at a certain point with current image analysis progress at the same point, visibility change can be judged on the basis of change in image analysis levels, and thus it can be judged that visibility is decreased without coming close to a point where analysis can be made.

Note that the analysis level should not be limited to determination depending on a type of road sign and presence or absence of a value written thereon, and there is another determination criterion. As to detection of a traffic signal, for example, assuming that existence of a signal and color thereof at a certain point were able to be determined in the past, if existence of the signal is only detected and color thereof cannot be recognized at the same point this time, the analysis level may be determined to be decreased. Also, any other threshold may be set.

In addition, while an image analysis history when a landmark can be completely recognized for the first time is employed as a determination criterion value and is used as a target when comparing with image analysis progress in the following driving in the above-described explanation, the image analysis history in the information storage unit 2a may be updated every time when image analysis progress is outputted from the image recognition unit 1a, and the image analysis progress at the previous time may be used as a comparison target. By employing such a configuration, determination whether visibility is better or worse than that at the previous time can be made.

Furthermore, while a vehicle position when a landmark can be completely recognized for the first time is employed as a reference position where the image recognition unit 1a outputs image analysis progress in the above-described explanation, the reference position may be updated. For example, multiple sets of an image analysis result and a detection position when a landmark can be completely recognized are recorded in the information storage unit 2a, and the reference position may be updated by employing a detection position having the best visibility. Here, determination whether visibility is good or poor may be made depending on the detection position (as detection position is farther from landmark, visibility is determined to be better), or may be made depending on the surrounding brightness. Also, after the reference position is determined for the first time, if the landmark is completely recognized again when the surroundings are brighter than the first time, the reference position may be updated by employing a newly obtained vehicle position.

By employing a configuration in which the reference position is updated in this way, even if visibility was poor when a landmark was completely recognized for the first time because of the bad weather, the reference position can be gradually corrected and thus performance of visibility estimation can be improved.

### Embodiment 3

While change in detection position of a landmark is used in visibility estimation in Embodiment 1 and change in image analysis level of a landmark is used in visibility estimation in Embodiment 2, change in distance from a detection position of a landmark to the landmark (detection distance) is used in visibility estimation in this embodiment.

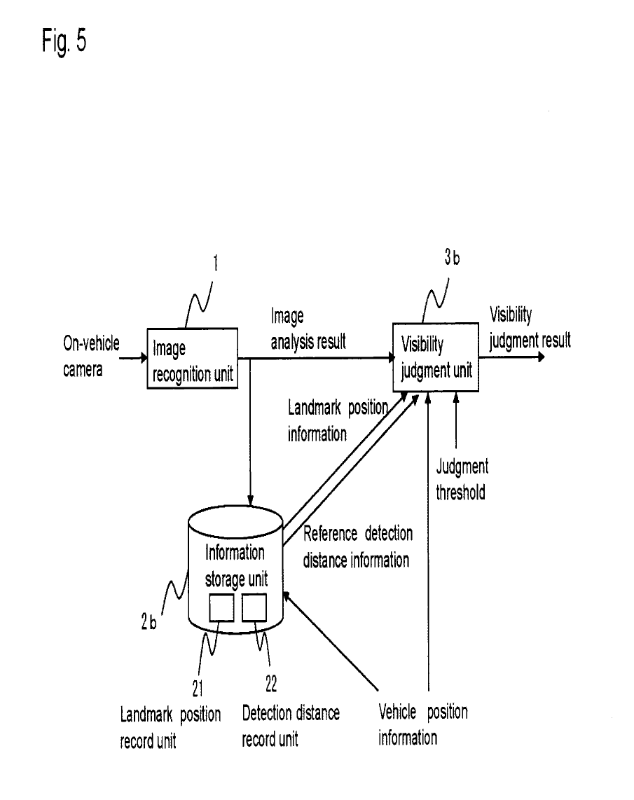

FIG. 5 is a diagram showing a driver's visibility estimation device according to Embodiment 3. Differences between FIG. 1 and FIG. 5 are that an information storage unit 2b includes a landmark position record unit 21 and a standard detection distance record unit 22 and that a plurality of data different from that in FIG. 1 is transmitted from the information storage unit 2b to a visibility judgment unit 3b. Since other than those are the same, the explanation thereof will be omitted.

Position information of landmarks such as road signs and traffic signals is recorded in the landmark position record unit 21 in the information storage unit 2b. In a car navigation device, etc., for example, since information about traffic signals is included in map information so as to display traffic signals at crossings, such information is utilized.

In the detection distance record unit 22 in the information storage unit 2b, a distance from a vehicle position where a landmark is detected for the first time to the landmark is recorded as a detection history used for visibility estimation. The distance is used as a reference detection distance (detection distance in the past) being a comparison target for a detection distance in the following driving. The reference detection distance is calculated as follows. When obtaining an image recognition result of a landmark from the image recognition unit 1 for the first time, the detection distance record unit 22 obtains vehicle position information as well as a position where the detected landmark is actually situated from the landmark position record unit 21 and comparers the information with the position so as to calculate a distance from the vehicle position to the landmark. For example, if the image recognition unit 1 detects a road sign situated in a vehicle traveling direction and outputs an image analysis result of “speed-limit sign” and “40 km/h”, the detection distance record unit 22 obtains position information of the road sign from the landmark position record unit 21. By comparing the obtained position of the road sign with the current vehicle position, the detection distance record unit 22 calculates a distance, e.g. “25 m”. That is, the fact that the vehicle can detect the road sign 25 m before the sign is recorded.

A judgment procedure of the visibility judgment unit 3b will be explained. When detecting an image of a landmark as a vehicle is approaching the landmark, the image recognition unit 1 outputs an image analysis result thereof to the visibility judgment unit 3b as well as to the information storage unit 2b. On receiving the image analysis result, the information storage unit 2b identifies the landmark recorded in the landmark position record unit 21 on the basis of the image analysis result and vehicle position information, and outputs position information of the landmark to the visibility judgment unit 3b. The information storage unit 2b also outputs information of reference detection distance corresponding to the identified landmark to the visibility judgment unit 3b.

On receiving the image analysis result from the image recognition unit 1, the visibility judgment unit 3b receives the vehicle position information at that time. The visibility judgment unit 3b calculates a distance from the vehicle to the landmark by using the inputted vehicle position information and the landmark position information. That is, a detection distance showing how short a distance is which is needed to detect the landmark this time is calculated. By comparing the calculated detection distance with the reference detection distance obtained from the information storage unit 2b, it is determined whether the former is shorter than a reference detection distance recorded in the past, i.e. whether or not the detection is made at a closer distance from the landmark. When making the comparison, a judgment threshold is used similar to the case in Embodiment 1. For example, if the reference detection distance is “25 m”, the detection distance calculated this time is “20 m”, and the threshold is “3 m”, the difference of 5 m between the reference detection distance and the detection distance calculated this time, i.e. a moving distance toward the landmark, exceeds the threshold, and thus it is determined as “visibility decreased”. On the other hand, if the detection distance of this time is “23 m”, a moving distance to the landmark of 2 m does not exceed the threshold, and thus the visibility judgment result is determined as “visibility normal”.

In this embodiment described above, the visibility judgment unit 3b calculates a detection distance, every time when the image recognition unit 1 detects a landmark, from the vehicle to the landmark at that time and compares the calculated detection distance with the reference detection distance recorded in the past, and thus estimates visibility.

Note that, while the detection distance when a landmark is detected for the first time is recorded in the detection distance record unit 22 as a reference value in the above-described explanation, the reference detection distance recorded in the detection distance record unit 22 may be updated every time when a landmark is detected. By employing such a configuration, determination whether visibility is better or worse than that at the previous time can be made. Also, the reference detection position may be obtained by averaging a plurality of detection distances. In addition, while a detection distance when visibility is good is recorded, update may not be made when visibility is estimated to be poor. If the reference detection distance is updated by using a detection distance when visibility is good, even if visibility was poor when a landmark was detected for the first time because of the bad weather, the reference detection distance can be gradually corrected and thus performance of visibility estimation can be improved.

### Embodiment 4

While the detection history of a single object (landmark) situated at a fixed position in the past is used for visibility estimation in the above-described Embodiments 1 through 3, a reference detection distance is recorded showing how short a distance is which is needed to detect each type of landmarks and the reference detection distance is used for visibility estimation in this embodiment. Since a basic configuration of a driver's visibility estimation device according to Embodiment 4 is the same as that in Embodiment 3, an operation of the present embodiment will be explained by using FIG. 5. As to the same configuration, the explanation thereof will be omitted.

In the detection distance record unit 22 in the information storage unit 2b, a reference detection distance showing how short a distance is which is needed to detect a landmark is recorded for each type of landmarks. A method of calculating the reference detection distance is similar to that in Embodiment 3. For example, there are recorded reference detection distances including “25 m” for a road sign such as a speed-limit sign, “30 m” for a traffic signal, and “40 m” for a shop signboard having a unified design of convenience store chain, etc. In this way, for each type of various landmarks, the detection distance record unit 22 records a distance detected for the first time for each type of the landmarks as the reference detection distance.

A judgment procedure of the visibility judgment unit 3b will be explained. When detecting an image of a certain type of landmark as a vehicle is approaching the landmark, the image recognition unit 1 outputs an image analysis result thereof to the visibility judgment unit 3b as well as to the information storage unit 2b. On receiving the image analysis result, the information storage unit 2b identifies the landmark recorded in the landmark position record unit 21 on the basis of the image analysis result and vehicle position information, and outputs position information of the landmark to the visibility judgment unit 3b. The information storage unit 2b also identifies a type of the landmark on the basis of the inputted image analysis result, and outputs, to the visibility judgment unit 3b, information of reference detection distance corresponding to the type of the landmark recorded in the detection distance record unit 22.

On receiving the image analysis result from the image recognition unit 1, the visibility judgment unit 3b receives the vehicle position information at that time. The visibility judgment unit 3b calculates a distance from the vehicle to the landmark detected this time by using the inputted vehicle position information and the landmark position information. The procedure of comparing the calculated detection distance with the reference detection distance and thus determining visibility change is similar to that in Embodiment 3.

In this embodiment described above, the visibility judgment unit 3b calculates, every time when the image recognition unit 1 detects a landmark, a distance from the vehicle to the landmark at that time and compares the calculated distance with the reference detection distance recorded for each type of landmarks, and thus judges visibility. Therefore, while there is an assumption that a landmark situated at a fixed position was already detected in the past in the above-described Embodiments 1 through 3, visibility can be estimated even when driving a road for the first time in this embodiment.

Note that, while the image analysis result is outputted to the visibility judgment unit 3b when a landmark can be completely recognized by the image recognition unit 1, which is similar to the case in Embodiment 1 and 3, in the above-described explanation, the image analysis progress may be outputted from the image recognition unit 1 at a predetermined reference position like the case in Embodiment 2. In this case, a complete image analysis result when a reference detection distance was recorded is compared to image analysis progress when a landmark of the same type is detected afterwards, and visibility is estimated on the basis of difference in analysis levels. Here, the reference position is situated at a position before a landmark by the reference detection distance recorded in association with a type of the landmark. Also in this way, an effect can be obtained in which visibility of a landmark can be estimated even when driving a road for the first time, i.e. even when the landmark situated at a fixed position is never detected in the past, as long as a landmark of the same type has been detected.

Also, while a detection distance when a certain type of landmark is detected for the first time is recorded as a reference detection distance in the detection distance record unit 22 in the above-described explanation, the reference detection distance recorded in the detection distance record unit 22 may be updated every time when a landmark of the same type is detected. In addition, an average value of a plurality of detection distances may be recorded. Furthermore, update of a reference detection position may be made by using a detection distance when visibility is good, and update may not be made when visibility is estimated to be poor.

### Embodiment 5

In the above-described Embodiments 1 through 4, a detection history in the past serving as a criterion for visibility estimation is recorded in the information storage unit 2 one by one for each landmark or for each type of landmarks. For example, a detection position (vehicle position information) is recorded for each landmark in Embodiment 1; an image analysis history is recorded for each landmark in Embodiment 2; a detection distance is recorded for each landmark in Embodiment 3; and a detection distance is recorded for each type of landmarks in Embodiment 4. In Embodiment 5, an example of selectively using a plurality of detection histories in accordance with usage conditions will be explained. Examples of the usage conditions include environmental conditions such as weather and brightness, and individual differences among users.

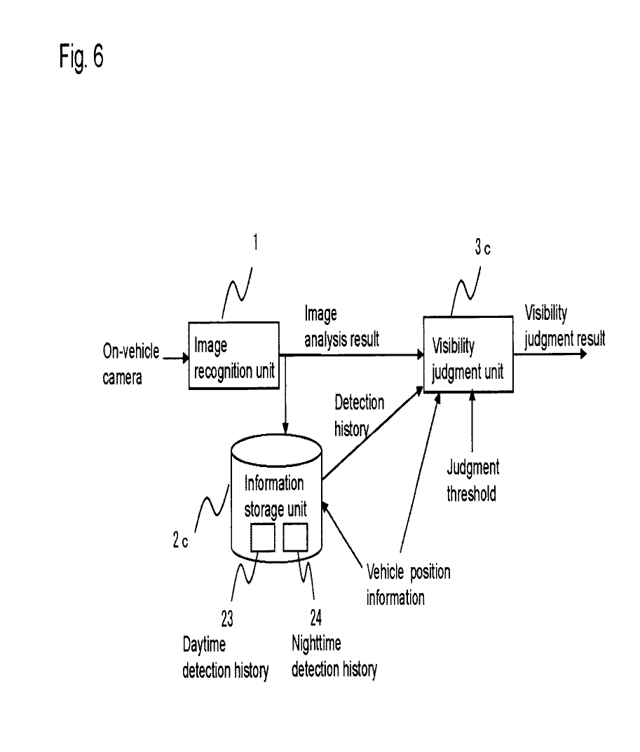

Object detection performance using an image analysis by the image recognition unit 1 differs depending on the environmental conditions such as weather and brightness. Thus, by using a rain sensor and an illuminance sensor, etc., different detection histories are provided for each of the environmental conditions such as weather and brightness which affect the detection performance of the image recognition unit 1. As shown in FIG. 6, for example, a daytime detection history record unit 23 and a nighttime detection history record unit 24 are provided in the information storage unit 2c. Like the case in Embodiment 1, for example, data in which an image analysis result detected during daytime is associated with vehicle position information at that time is recorded in the daytime detection history record unit 23, and data in which an image analysis result detected during nighttime is associated with vehicle position information at that time is recorded in the nighttime detection history record unit 24. Similar to Embodiment 1, the vehicle position information serves as reference detection position information and is used as a determination criterion when estimating visibility.

When visibility estimation judgment is started as a vehicle is approaching a point where a landmark was detected in the past, if it is determined to be daytime by using an illuminance sensor or on the basis of the time, etc., an image analysis result and vehicle position information recorded in the daytime detection history record unit 23 are outputted to the visibility judgment unit 3c as the detection history. The visibility judgment unit 3c compares the vehicle position information detected this time with vehicle position information obtained from the daytime detection history record unit 23, i.e. a reference detection position, and estimates visibility. Since other operations are similar to those in Embodiment 1, the explanation thereof will be omitted.

Note that detection histories recorded in the daytime detection history record unit 23 and nighttime detection history record unit 24 may not be the above-described data in which the image analysis result is associated with the vehicle position information. For example, an image analysis result detected during daytime and an image analysis result detected during nighttime may be recorded as is in Embodiment 2; a detection distance when a landmark is detected during daytime and a detection distance when a landmark is detected during nighttime may be recorded as is in Embodiment 3; and a detection distance for daytime and a detection distance for nighttime may be recorded for each of landmarks as is in Embodiment 4.

Also, three or more detection history record units may be provided in accordance with illuminance detected by the illuminance sensor. In addition, a detection history record unit for rainy weather and a detection history record unit for fine weather may be provided using a rain sensor.

Furthermore, since visibility is affected by individual differences such as driving skill and visual acuity of a driver being a user, a detection history recorded in the information storage unit 2 may be separately provided for each driver by using some means for identifying the driver. For example, data in which an image analysis result detected in the past is associated with vehicle position information at that time is divided into multistage data and is recorded. That is, data detected under a good visibility condition and data detected under a poor visibility condition are recorded. Since a vehicle position detected under a poor visibility condition is closer to a landmark than a vehicle position detected under a good visibility condition, if the data detected under a poor visibility condition is used as a reference value for a driver having good visual acuity, probability of determining “visibility decreased” is reduced, and thus frequently displaying a warning, etc. can be avoided.

By recording detection histories being different in accordance with usage conditions and employing, as a comparison target, the detection history being different in accordance with the usage condition in this way, visibility change can be estimated more precisely.

### Embodiment 6

While an example is explained in the above-described Embodiment 5 in which a plurality of detection histories is used in accordance with usage conditions, a threshold using in visibility estimation may be changed in accordance with the usage condition. For example, since visibility in daytime is better than that in nighttime, a threshold for daytime is set to be larger than that for nighttime. In the example in Embodiment 1, if a landmark is detected when moving toward the landmark by 3 in from the reference detection position, “visibility decreased” is determined if the threshold is 2 m, but “visibility normal” is determined if the threshold is 4 m. Therefore, if a daytime threshold is set to be 4 m and a nighttime threshold is set to be 2 m, probability of determining “visibility decreased” is reduced during daytime, and thus frequently displaying a warning, etc. can be avoided.

Similar to the case in Embodiment 5, a threshold may be set in accordance with weather and illuminance. Also, a threshold may be set for each driver similar to the case in Embodiment 5. For example, if a button for increasing a threshold for determining decrease in visibility is provided and if a driver who feels that too much information is provided presses this button, probability of determining decrease in visibility can be reduced. On the other hand, a button for reducing a threshold for determining decrease in visibility may be provided and a driver having poor visual acuity may press this button so that decrease in visibility is determined even if a slight change occurs at a position of detecting a road sign.

### Embodiment 7

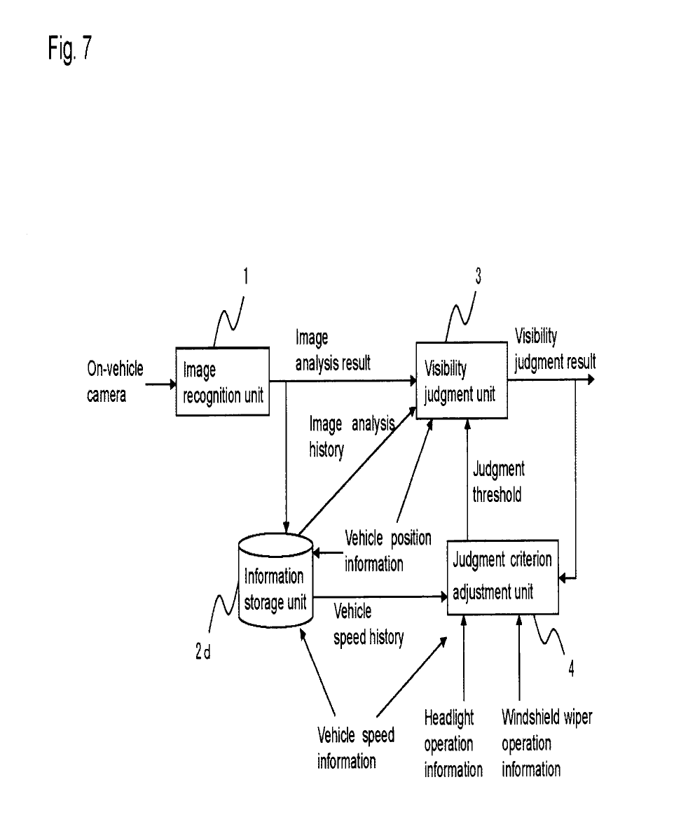

FIG. 7 is a diagram showing a driver's visibility estimation device according to Embodiment 7. Differences between FIG. 1 and FIG. 7 are that a judgment criterion adjustment unit 4 for generating a judgment threshold is provided and that input of vehicle speed information and output of a vehicle speed history are added to an information storage unit 2d. Since other than those are the same, the explanation thereof will be omitted.

While a judgment threshold is referred to when judging whether or not visibility is decreased in the above-described embodiments, the judgment criterion adjustment unit 4 in Embodiment 7 has a function of adjusting such a threshold, and, from among various cases, an operation of increasing a threshold, i.e. probability of determining decrease in visibility by the visibility judgment unit 3 is reduced, will be shown in this embodiment.

If decrease in visibility is determined as a visibility judgment result, the judgment criterion adjustment unit 4 estimates whether a driver being a user actually feels that visibility is decreased. Specifically, it is estimated that some change occurs in operating conditions of a windshield wiper or headlights and in a vehicle speed, etc. if a driver feels decrease in visibility, and change thereof is monitored. That is, change in driver's behavior is monitored.

When using the change in windshield wiper usage, the judgment criterion adjustment unit 4 obtains windshield wiper operation information (on/off, operation speed) from a windshield wiper control device, and observes whether an operation of activating a windshield wiper by turning on a windshield wiper switch or of accelerating an operation speed of windshield wiper is made during a predetermined period. If such an operation has not been made, it is determined that the driver does not feel decrease in visibility.

When using the change in headlight usage, the judgment criterion adjustment unit 4 obtains headlight operation information (on/off) from a headlight and fog lamp control device, and observes whether an operation of turning on a headlight switch is made during a predetermined period. If a lighting operation of turning on the headlight switch has not been made, it is determined that the driver does not feel decrease in visibility.

An explanation of a case of combining with, for example, the visibility estimation method in Embodiment 1 will be made. In a case of using the change in vehicle speed, the information storage unit 2d also records the obtained vehicle speed information as a vehicle speed history when an image analysis result and vehicle position information are associated with each other and stored. If a landmark is detected by the image recognition unit 1, the judgment criterion adjustment unit 4 compares the current vehicle speed with a vehicle speed history of the same landmark in the past obtained from the information storage unit 2d, and observes whether or not the vehicle running speed is slower than that when passing by the same point in the past. If the vehicle speed is not reduced, it is determined that the driver does not feel decrease in visibility.

If decrease in visibility is determined as a visibility judgment result, and if it is determined that the driver does not feel decrease in visibility on the basis of the above-described change in any one of windshield wiper usage, headlight usage, and a vehicle speed, or a combination thereof, the judgment criterion adjustment unit 4 increases a judgment threshold to be notified to the visibility judgment unit 3. In this way, probability of determining decrease in visibility by the visibility judgment unit 3 is reduced when detecting the same landmark in the following driving. An explanation will be made by using, for example, the visibility estimation method in Embodiment 3. If the reference detection distance is “25 m”, the detection distance calculated this time is “20 m”, and the threshold is “3 m”, the difference of 5 m between the reference detection distance and the detection distance calculated this time exceeds the threshold, and thus it is determined as “visibility decreased”. However, since the driver does not actually feel decrease in visibility, the threshold is set to be “6 m” in the following driving so that it will not be determined as “visibility decreased”.

As described above, while a judgment result of decrease in visibility is outputted, a function is provided in which a threshold is increased when it is actually estimated that a driver does not feel decrease in visibility on the basis of change in driver's behavior. Therefore, an excessive determination of decrease in visibility can be avoided when the driver does not feel that visibility is decreased, and an excessive display of warning, etc. accompanied thereby can be suppressed.

### Embodiment 8

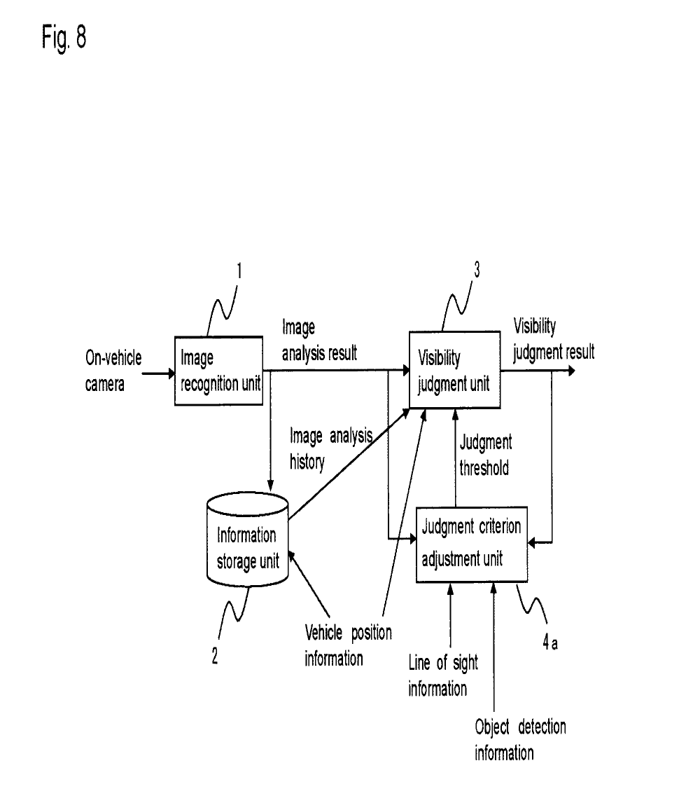

FIG. 8 is a diagram showing a driver's visibility estimation device according to Embodiment 8. A difference between FIG. 1 and FIG. 8 is that a judgment criterion adjustment unit 4a for generating a judgment threshold is provided. Since other than that are the same, the explanation thereof will be omitted.

While the operation of increasing the judgment threshold inputted to the visibility judgment unit 3 is shown in the above-described Embodiment 7, an operation is shown in Embodiment 8 in a case when the judgment criterion adjustment unit 4a reduces the threshold, i.e. probability of determining decrease in visibility by the visibility judgment unit 3 is increased.

In a case when, although decrease in visibility is not determined by the visibility judgment unit 3, it is needed to positively display a warning such as approaching to obstacles in the following driving, it is necessary to increase probability of determining decrease in visibility by the visibility judgment unit 3, i.e. reduce the judgment threshold. Specifically, it is a situation that a driver being a user does not notice decrease in visibility and since change in driver's behavior such as delay in detecting a pedestrian, etc. on the road shoulder can be observed, such change is detected.

As for detecting a pedestrian on the road shoulder, detection information of an object ahead such as a pedestrian is obtained first. An image analysis result of the image recognition unit 1 may be used as the information, or the information may be obtained from another on-vehicle camera or a device for recognizing an image. Meanwhile, determination whether or not the driver notices a pedestrian ahead, etc. needs information on driver's line of sight. This can be obtained by detecting eye movement from an image, etc. captured by an in-vehicle camera disposed toward a driver's seat instead of the outside of vehicle.

Behavior of delay in detecting a pedestrian is a case of obtaining line of sight information in which, although an object position as object detection information is notified to the judgment criterion adjustment unit 4a, the line of sight is not directed to the object position after a predetermined period. In this case, since it is understood that the driver does not notice decrease in visibility, a judgment threshold to be notified to the visibility judgment unit 3 is reduced. An explanation will be made by using, for example, the visibility estimation method in Embodiment 3. If the reference detection distance is “25 m”, the detection distance calculated this time is “22 m”, and the threshold is “4 m”, the difference of 3 m between the reference detection distance and the detection distance calculated this time does not exceed the threshold, and thus it is determined as “visibility normal”. However, since it can be estimated in practice that the driver does not notice decrease in visibility, the threshold is set to be “2 m” in the following driving so that it will be determined as “visibility decreased”.

Note that, when a pedestrian abruptly appears from a byway, etc., a time between notification of object detection information to the judgment criterion adjustment unit 4a and movement of line of sight toward an object position is short, and thus it does not mean decrease in visibility. In this case, the operation of increasing the threshold is not performed.

As described above, even when decrease in visibility is not determined by the visibility judgment unit 3, the function of reducing the threshold is provided if it can be estimated that the driver does not notice decrease in visibility such as a case when a predetermined time is needed before the driver's line of sight moves toward the detected object ahead. Therefore, probability of determining decrease in visibility is increased, and a necessary display of warning, etc. accompanied thereby can be provided to the driver.

### Embodiment 9

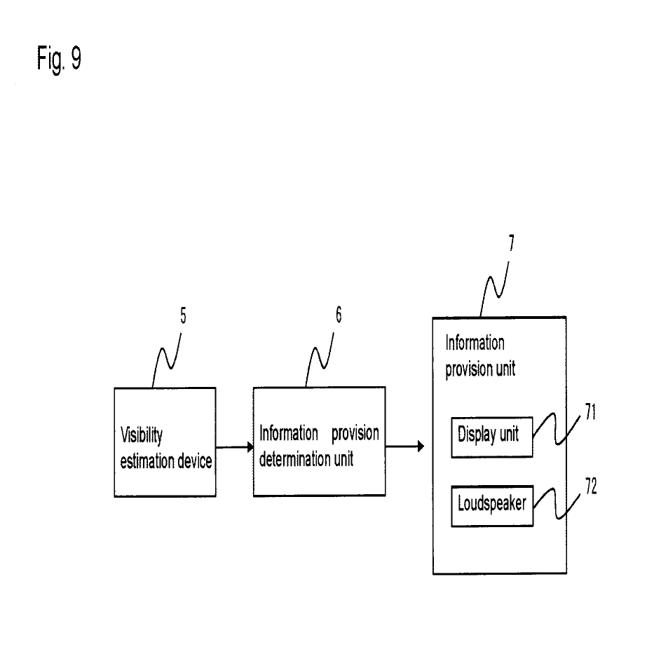

A visibility judgment result of the visibility estimation devices in the above-described embodiments is used in a safe driving support system, for example. FIG. 9 is a diagram showing an outline of a safe driving support system. In FIG. 9, Reference Numeral (RF) 5 is one of the visibility estimation devices explained in the above-described embodiments, RF 6 is an information provision determination unit that determines whether or not provide information regarding surrounding objects to a driver being a user by using a visibility judgment result of the visibility estimation device 5, and RF 7 is an information provision unit that provides the information to the driver on the basis of the determination by the information provision determination unit 6 and that includes a display unit 71 for providing an image and a loudspeaker 72 for providing a voice.

The information provision determination unit 6 changes a provision criterion, i.e. threshold, of various pieces of safety support information to the driver on the basis of the visibility judgment result. For example, when a warning that a following distance to a preceding vehicle is shorter than a predetermined distance is provided and when the visibility judgment result of the visibility estimation device 5 is “visibility decreased”, the provision criterion is reduced so that the information provision unit 7 provides a warning by using a display or a voice even if the distance thereto is longer than usual. The control in this way makes a driver behave in a mentally relaxed manner. Also, when existence of preceding pedestrians and bicycles, etc. is notified, the existence of pedestrians and bicycles difficult to recognize is notified to the driver only when the visibility judgment result is “visibility decreased”, i.e. only when special attention is needed.

In addition, when the visibility judgment result of the visibility estimation device 5 is “visibility decreased” during a car navigation function is in use, for example, a point to turn next may be indicated by a voice at a timing earlier than usual, and lighting headlights and fog lamps may be encouraged by a display or a voice, or they may be turned on automatically in response to decrease in visibility.

As described above, since the visibility judgment result of the visibility estimation devices in Embodiments 1 through 8 not only estimates visibility of a certain landmark at a certain point of time but also estimates change in visibility compared to the past, the result can be used as a criterion when necessity of providing safety support information regarding surrounding objects is determined, and thus excessive provision of information to a driver can be suppressed. That is, when visibility is decreased, a provision criterion is reduced so that the safety support information regarding surroundings which is not provided usually can be provided, and thus excessive notification of information regarding surroundings to the driver can be avoided under good visibility conditions.

### REFERENCE NUMERALS

1 image recognition unit; 2 information storage unit; 21 landmark position record unit; 22 detection distance record unit; 23 daytime detection history; 24 nighttime detection history; 3 visibility judgment unit; 4 judgment criterion adjustment unit; 5 visibility estimation device; 6 information provision determination unit; 7 information provision unit; 71 display unit; and 72 loudspeaker.

1-13. (canceled)

14: A visibility estimation device comprising:
an image recognizer to detect a landmark by analyzing an image;
an information storage to record, as a detection history regarding the landmark in the past, an image analysis result of the landmark detected by the image recognizer and a detection position where the landmark is detected by the image recognizer; and
a visibility judger to estimate, in a case when the landmark corresponding to the detection history is detected again by the image recognizer, change in visibility on the basis of comparison between a detection position in the case and the detection position in the past recorded in the information storage.

15: The visibility estimation device in claim 14, wherein:
a plurality of detection histories is recorded by the information storage in accordance with a plurality of usage conditions; and
one of the detection histories being different in accordance with each of the usage conditions is employed by the visibility judger as a comparison target.

16: The visibility estimation device in claim 14, wherein a threshold is used by the visibility judger in the comparison for estimating the change in visibility and the threshold is changed in accordance with a usage condition.

17: The visibility estimation device in claim 14, wherein:
a threshold is used by the visibility judger in the comparison for estimating the change in visibility; and
a judgment criterion adjuster is provided to adjust, when the change in visibility is estimated by the visibility judger, the threshold on the basis of change in user's behavior.

18: The visibility estimation device in claim 17, wherein the threshold is increased in a case when decrease in visibility is estimated by the visibility judger and when it is estimated that a user does not feel the decrease in visibility on the basis of the change in the user's behavior.

19: The visibility estimation device in claim 17, wherein the threshold is reduced in a case when decrease in visibility is not estimated by the visibility judger and when it is estimated that a user does not notice the decrease in visibility on the basis of the change in the user's behavior.

20: A visibility estimation device comprising:
an image recognizer to detect a landmark by analyzing an image;
an information storage to record, as a detection history regarding the landmark in the past, an image analysis result of the landmark detected by the image recognizer and a detection position where the landmark is detected by the image recognizer; and
a visibility judger to estimate change in visibility on the basis of comparison between image analysis progress of the landmark analyzed again by the image recognizer at the detection position in the past recorded in the information storage and the image analysis result in the past recorded in the information storage.

21: The visibility estimation device in claim 20, wherein:
the detection history is recorded by the information storage for each type of landmarks; and
the change in visibility is estimated by the visibility judger in a case when a landmark being a same type with the landmark corresponding to the detection history is detected again by the image recognizer.

22: The visibility estimation device in claim 20, wherein:
a plurality of detection histories is recorded by the information storage in accordance with a plurality of usage conditions; and
one of the detection histories being different in accordance with each of the usage conditions is employed by the visibility judger as a comparison target.

23: The visibility estimation device in claim 20, wherein a threshold is used by the visibility judger in the comparison for estimating the change in visibility and the threshold is changed in accordance with a usage condition.

24: The visibility estimation device in claim 20, wherein:
a threshold is used by the visibility judger in the comparison for estimating the change in visibility; and
a judgment criterion adjuster is provided to adjust, when the change in visibility is estimated by the visibility judger, the threshold on the basis of change in user's behavior.

25: The visibility estimation device in claim 24, wherein the threshold is increased in a case when decrease in visibility is estimated by the visibility judger and when it is estimated that a user does not feel the decrease in visibility on the basis of the change in the user's behavior.

26: The visibility estimation device in claim 24, wherein the threshold is reduced in a case when decrease in visibility is not estimated by the visibility judger and when it is estimated that a user does not notice the decrease in visibility on the basis of the change in the user's behavior.

27: A visibility estimation device comprising:
an image recognizer to detect a landmark by analyzing an image;
an information storage to record, as a detection history regarding the landmark in the past, a detection distance from a position where the landmark is detected by the image recognizer to the landmark; and
a visibility judger to estimate, in a case when the landmark corresponding to the detection history is detected again by the image recognizer, change in visibility on the basis of comparison between a detection distance in the case and the detection distance in the past recorded in the information storage.

28: The visibility estimation device in claim 27, wherein:
the detection history is recorded by the information storage for each type of landmarks; and
the change in visibility is estimated by the visibility judger in a case when a landmark being a same type with the landmark corresponding to the detection history is detected again by the image recognizer.

29: The visibility estimation device in claim 27, wherein:
a plurality of detection histories is recorded by the information storage in accordance with a plurality of usage conditions; and
one of the detection histories being different in accordance with each of the usage conditions is employed by the visibility judger as a comparison target.

30: The visibility estimation device in claim 27, wherein a threshold is used by the visibility judger in the comparison for estimating the change in visibility and the threshold is changed in accordance with a usage condition.

31: The visibility estimation device in claim 27, wherein:
a threshold is used by the visibility judger in the comparison for estimating the change in visibility; and
a judgment criterion adjuster is provided to adjust, when the change in visibility is estimated by the visibility judger, the threshold on the basis of change in user's behavior.

32: The visibility estimation device in claim 31, wherein the threshold is increased in a case when decrease in visibility is estimated by the visibility judger and when it is estimated that a user does not feel the decrease in visibility on the basis of the change in the user's behavior.

33: The visibility estimation device in claim 31, wherein the threshold is reduced in a case when decrease in visibility is not estimated by the visibility judger and when it is estimated that a user does not notice the decrease in visibility on the basis of the change in the user's behavior.

34: A visibility estimation device comprising:
an image recognizer to detect a landmark by analyzing an image;
an information storage to record a reference detection distance from a position where the landmark can be detected by the image recognizer to the landmark; and
a visibility judger to estimate, in a case when the landmark is detected by the image recognizer, change in visibility on the basis of comparison between a detection distance in the case and the reference detection distance recorded in the information storage.

35: The visibility estimation device in claim 34, wherein:
the reference detection distance is recorded by the information storage for each type of landmarks; and
the change in visibility is estimated by the visibility judger, in a case when a landmark is detected by the image recognizer, by using a reference detection distance, recorded in the information storage, of a landmark being a same type with the detected landmark.

36: The visibility estimation device in claim 34, wherein a threshold is used by the visibility judger in the comparison for estimating the change in visibility and the threshold is changed in accordance with a usage condition.

37: The visibility estimation device in claim 34, wherein:
a threshold is used by the visibility judger in the comparison for estimating the change in visibility; and
a judgment criterion adjuster is provided to adjust, when the change in visibility is estimated by the visibility judger unit, the threshold on the basis of change in user's behavior.

38: The visibility estimation device in claim 37, wherein the threshold is increased in a case when decrease in visibility is estimated by the visibility judger and when it is estimated that a user does not feel the decrease in visibility on the basis of the change in the user's behavior.

39: The visibility estimation device in claim 37, wherein the threshold is reduced in a case when decrease in visibility is not estimated by the visibility judger and when it is estimated that a user does not notice the decrease in visibility on the basis of the change in the user's behavior.

40: A safe driving support system comprising:
an image recognizer to detect a landmark by analyzing an image;
an information storage to record, as a detection history regarding the landmark in the past, an image analysis result of the landmark detected by the image recognizer and a detection position where the landmark is detected by the image recognizer;
a visibility judger to estimate, in a case when the landmark corresponding to the detection history is detected again by the image recognizer, change in visibility on the basis of comparison between a detection result in the case and the detection history in the past recorded in the information storage;
an information provision determinator to reduce, when current visibility is estimated by the visibility judger to be decreased compared to visibility in the past, a threshold for determining that safety support information regarding surroundings is necessary to be provided to a user; and
a display to provide, when provision of the information is determined by the information provision determinator, the information to the user.

41: A safe driving support system comprising:
an image recognizer to detect a landmark by analyzing an image;
an information storage to record, as a detection history regarding the landmark in the past, an image analysis result of the landmark detected by the image recognizer and a detection position where the landmark is detected by the image recognizer;
a visibility judger to estimate, in a case when the landmark corresponding to the detection history is detected again by the image recognizer, change in visibility on the basis of comparison between a detection result in the case and the detection history in the past recorded in the information storage;
an information provision determinator to reduce, when current visibility is estimated by the visibility judger to be decreased compared to visibility in the past, a threshold for determining that safety support information regarding surroundings is necessary to be provided to a user; and
a speaker to provide, when provision of the information is determined by the information provision determinator, the information to the user.
